(19) United States
(12) Patent Application Publication
(10) Pub. No.: US 2013/0207406 A1
(43) Pub. Date: Aug. 15, 2013

(54) FOOT-OPERATED DOOR-OPENER

(71) Applicant: Metiba Verwaltungs GmbH, (US)

(72) Inventor: Sascha KLEIN, Garbsen (DE)

(73) Assignee: Metiba Verwaltungs GmbH, Garbsen (DE)

(21) Appl. No.: 13/777,719

(22) Filed: Feb. 26, 2013

Related U.S. Application Data
(63) Continuation of application No. PCT/EP2011/004255, filed on Aug. 25, 2011.

(30) Foreign Application Priority Data
Aug. 26, 2010 (DE) 10 2010 035 544.2

(51) Int. Cl. E05B 53/00

(52) U.S. Cl. CPC E05B 53/001
USPC 292/255

(57) ABSTRACT

A foot-operated door-opener, includes a foot-operated actuator element provided in a lower region of a door for opening the door. The foot-operated actuator element includes an upper and a lower foot surface element that are connected to each other by a hinge and, when operated by a user's foot, each upper and lower foot surface element pivots at least partially into the interior of the door. The one or more upper and lower foot surface elements are guided in a guide slot, and the guide slot may have a course which is diagonal, vertical, paraboloid-like, or a combination of such.

### CROSS-REFERENCE TO RELATED APPLICATIONS

This application is a continuation of application no. PCT/EP2011/004255, filed Aug. 25, 2011, which claims the priority of German Application No. 10 2010 035 554.2, filed Aug. 26, 2010, and each of which is incorporated herein by reference.

### FIELD OF THE INVENTION

The invention relates to a foot-operated door opener having a foot-operated actuator element, situated in the lower area of a door, for opening the door.

### BACKGROUND OF THE INVENTION

DE 101 13 865 A1 discloses a device for opening a door, in particular in wet areas, an actuating member which is used for actuation with the foot being provided in the door, and the actuating member being configured as a rod which projects from the door.

EP 1 048 811 A1 discloses in particular a door opening system equipped with a foot pedal situated next to the door, whereby an actuator rod engages directly with a door opening mechanism.

WO 02/31297 A1 discloses a door opening mechanism which translates a translational motion by a footrest into a rotational motion of a member which engages directly with a door opening mechanism.

U.S. Pat. No. 5,193,863 and U.S. Pat. No. 4,569,546 disclose a foot-operated door opener which is mounted on the door in a flap-like manner, so that as the result of activation by placing a foot on a plate-shaped, rotatable footrest element, an actuator rod undergoes a translational motion, thus allowing the door to be opened by engagement with an opening mechanism of the door.

U.S. Pat. No. 4,621,848 discloses a foot-operated door opener in which a user may activate a pedal-shaped foot element which projects from the door, so that a door may be opened by means of a translational motion from top to bottom, with direct engagement with an opening mechanism of the door via an actuator rod.

EP 1 378 622 A2 discloses a foot-operated door opener having a foot-operated actuator element, mounted on a door in the lower area, for opening the door.

U.S. Pat. No. 1,611,386 discloses a foot-operated actuator which is situated outside a door and provided with a rod, and which is articulatedly connected to the foot-operated actuator element, so that the respective rotating and pivoting motion of the foot-operated actuator via the rod is additionally transferred to an opening and closing mechanism installed on the door.

All of these foot-operated door opening devices known from the PRIOR ART share the common feature that on the one hand, they allow opening of the door by means of a foot in a relatively rough, imprecise manner, and on the other hand, they entail a certain potential for injury during operation owing to sometimes unwieldy geometries.

### OBJECTS AND SUMMARY OF THE INVENTION

An object of the invention is to overcome the drawbacks of the prior art.

An object of the invention, therefore, is to avoid one or more of the above-described disadvantages.

These and other objects of the invention are achieved by a foot-operated door opener according to the invention as set forth herein.

In sum, the invention includes a foot-operated door opener, including:
a) a foot-operated actuator element, the foot-operated actuator element configured for being situated in a lower area of a door having an interior and exterior, for opening the door;
b) the foot-operated actuator element having an upper and a lower foot surface element which are articulatedly connected to one another and, when operated by a foot, each upper and lower foot surface element pivots at least partially into the interior of the door; and
c) at least one of the upper and lower foot surface elements being guided in a guide slot.

Further, the invention includes a door having a foot-operated door opener, including:
a) a foot-operated actuator element, the foot-operated actuator element configured for being situated in a lower area of a door having an interior and exterior, for opening the door;
b) the foot-operated actuator element having an upper and a lower foot surface element which are articulatedly connected to one another and, when operated by a foot, each upper and lower foot surface element pivots at least partially into the interior of the door; and
c) at least one of the upper and lower foot surface elements being guided in a guide slot.

Still further, the invention includes use of a foot-operated door opener for installation in a door, the foot-operated door opener, comprising:
a) a foot-operated actuator element, the foot-operated actuator element configured for being situated in a lower area of a door having an interior and exterior, for opening the door;
b) the foot-operated actuator element having an upper and a lower foot surface element which are articulatedly connected to one another and, when operated by a foot, each upper and lower foot surface element pivots at least partially into the interior of the door; and
c) at least one of the upper and lower foot surface elements being guided in a guide slot.

The foot-operated door opener according to the invention is equipped with a foot-operated actuator element, situated in the lower area of a door, for opening the door. It is advantageous that the foot-operated door opener is essentially free of projection beyond the door profile in the unactivated state, i.e., that the foot-operated door opener does not project beyond the door profile. As a result of this configuration, the risk of injury is greatly reduced as no unwieldy elements project from the door.

The projection-free door profile is achieved, for example and in particular, by the foot-operated actuator element having at least one foot surface element which during use is at least partially pivoted inwardly, so that as a result of the user placing the foot on the generally plate-like foot surface element and pressing down, inward pivoting also takes place, thus allowing relatively fine-motor operability, even for slowly opening the door in question, since from a physiological standpoint, pivoting motions are generally more finely adjustable than purely translational motions.

The foot-operated door opener according to the invention is composed of multiple components, in particular a foot-operated actuator element, which for example and in particular generally has a plate-like foot surface element, and an actuator element which generally translates the pivoting motion into a translational motion, the actuator element often having a rod- or cable-shaped configuration, so that the actuator element may then be fastened to a conventional door opening mechanism for then operating the foot-operated actuator element via the actuator element, and the door may then be opened by engagement with the opening mechanism of the door.

The individual parts of the foot-operated door opener according to the invention may in particular be of a metallic nature, for example and in particular made of stainless steel or of aluminum alloys.

It is fundamental to the invention that the foot-operated actuator element has an upper and a lower foot surface element, both generally also having a plate-like configuration and being articulatedly connected to one another, and when operated by a foot, in each case pivoting at least partially into the interior of the door.

The pivoting of both foot surface elements results in a larger “space” in the door, so that any catching at inner edges of the door is significantly reduced. As a result of this special configuration, it is easier for the user to open the door in question, since in comparison to a configuration having only one foot surface element, a larger “tread surface,” i.e., the surface to be encountered by a foot, is available for opening the door. In addition, owing to the larger “space,” the risk of the foot being caught when it is withdrawn is lower.

In addition, if at least one foot surface element is guided in a guide slot, it is particularly advantageous according to the invention when a) the upper foot surface element is guided in a first guide slot and the lower foot surface element is guided in a second guide slot, or vice versa, or b) the upper and the lower foot surface elements are guided in a single guide slot, since reliable, reproducible functionality is thus provided, and distortion of the elements relative to one another and possible jamming are thus reduced to a minimum.

Furthermore, it is advantageous if the courses of the two guide slots are different; in practice, it has proven to be suitable when the first and/or second guide slot(s) has/have a diagonal course, the second guide slot has a paraboloid-like course, a portion of the second guide slot has a diagonal course, a portion of the second guide slot has a vertical course, and the second guide slot has a paraboloid-like course, followed by a vertical course and then by a diagonal-like course, since a precise adaptation to the particular application with regard to the fine-motor adjustability is provided with the aid of these configurations.

The balance between pivoting and the component of a translational motion may be set [via] the degree of diagonality, i.e., the extent to which the courses run straight and at an angle, as well as via the nature of the paraboloid, since as a rule, during the pivoting the translation component determines the degree of activation of an opening mechanism of the door, since an actuator element, which in particular is configured in the form of a rod or a cable, generally directly or indirectly functions as an intermediate member between the foot surface element or the foot-operated actuator element and the actual opening mechanism of the door, namely, as an actuator element.

Of course, it is also conceivable to implement other guide slot courses, for example with a first diagonal course followed by a vertical course, which in turn is followed by a paraboloid-like course.

It is also advantageous if the articulated connection of the two foot surface elements is achieved by means of at least one guide slot running element, which is generally rod-shaped and extends as a rod in a guide slot, in particular the at least one guide slot running element being guided in the first or second guide slot, or in a single guide slot. In particular, the first guide slot is the guide slot of the upper foot surface element, and the second guide slot is the guide slot of the lower foot surface element. During pivoting of the lower foot surface element, a synchronous forced pivoting of the upper foot surface element which is adapted to the course of the guide slot thus takes place at the same time, which, however, represents an effective configuration with regard to the adaptability of the pivoting of both foot surface elements relative to one another as a function of the absolute pivoting of the lower foot surface element.

According to the invention, the foot-operated door opener may also have only a single guide slot.

Furthermore, it is advantageous if at least one first spring element directly or indirectly engages with at least one foot surface element in such a way that the foot surface element is pulled into a neutral position without foot resistance from an operator, advantageously in such a way that both foot surface elements stay in a vertical position, and thus, in the ideal case in flush alignment with the door surface, in a manner of speaking.

In this regard, it is advantageous if the courses of the two guide slots are different, so that releasing a foot surface element causes at least partial retraction into the neutral position with frictional guiding of the first, or an additional, guide slot running element, since, depending on the geometric configuration and characteristic of the friction of the guide slot running element in the guide slot, a damped retraction, so to speak, into the neutral position is thus made possible, and the situation is generally avoided that at least one spring element pulls the foot surface elements, unbraked, into their neutral positions at corresponding stops, which usually involves a high noise level.

In this regard, it is advantageous if the first spring element engages with the first, or an additional, guide slot running element.

Furthermore, since in practice it has proven to be suitable, in this regard it is advantageous if the first spring element, or additionally a further second spring element, directly or indirectly engages with an opening mechanism of the door.

It is also advantageous if the spring constants of the two spring elements have different valves, in particular if the spring constants of the two spring elements differ from one another such that the door to be opened is opened in an adjustable manner when the foot-operated actuator element is operated, since a precise setting is thus possible between the opening of the opening mechanism of the door and the extent of pivoting of the foot surface element or of the two foot surface elements. For example, it is conceivable for two spring elements to be connected in series in mutual interaction, so that, due to a relatively low spring constant and thus a relatively high flexibility of the first spring element, then via a relatively high spring constant so that the second spring element undergoes relatively little extension with the same application of force, beginning at a certain point in time of the pivoting, the resultant translational path, or, for a rotary motion, the corresponding rotational path, is sufficient to activate the door mechanism of the door in such a way that the door may be opened.

Furthermore, it is conceivable to use shock absorbers, for example gas pressure shock absorbers or oil pressure shock absorbers, instead of spring elements.

Relating terms such as, up, down, left, and right are for convenience only and are not intended to be limiting.

The invention is described below in a nonlimiting manner with reference to one embodiment and the associated four figures.

### BRIEF DESCRIPTION OF THE DRAWINGS

FIG. 1 shows a three-dimensional illustration showing a view from the front of one embodiment of the foot-operated door opener according to the invention;

FIG. 2 shows the embodiment shown in FIG. 1 during operation;

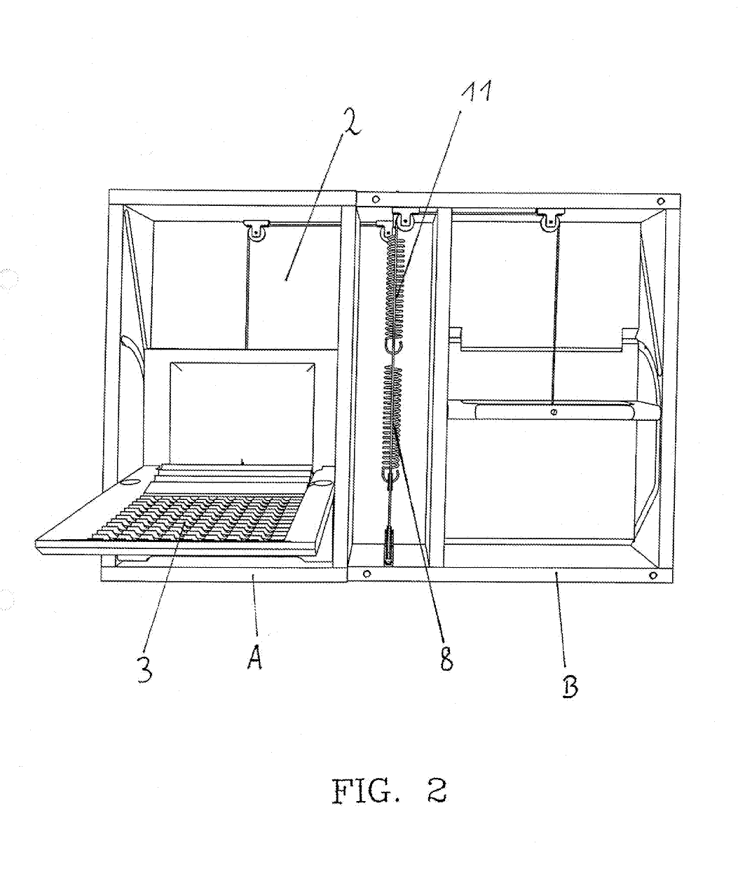

FIG. 3 shows a front view of the embodiment shown in FIGS. 1 and 2, from a different perspective; and

FIG. 4 shows the embodiment illustrated in FIGS. 1 through 3 in the installed state.

### DETAILED DESCRIPTION OF THE INVENTION

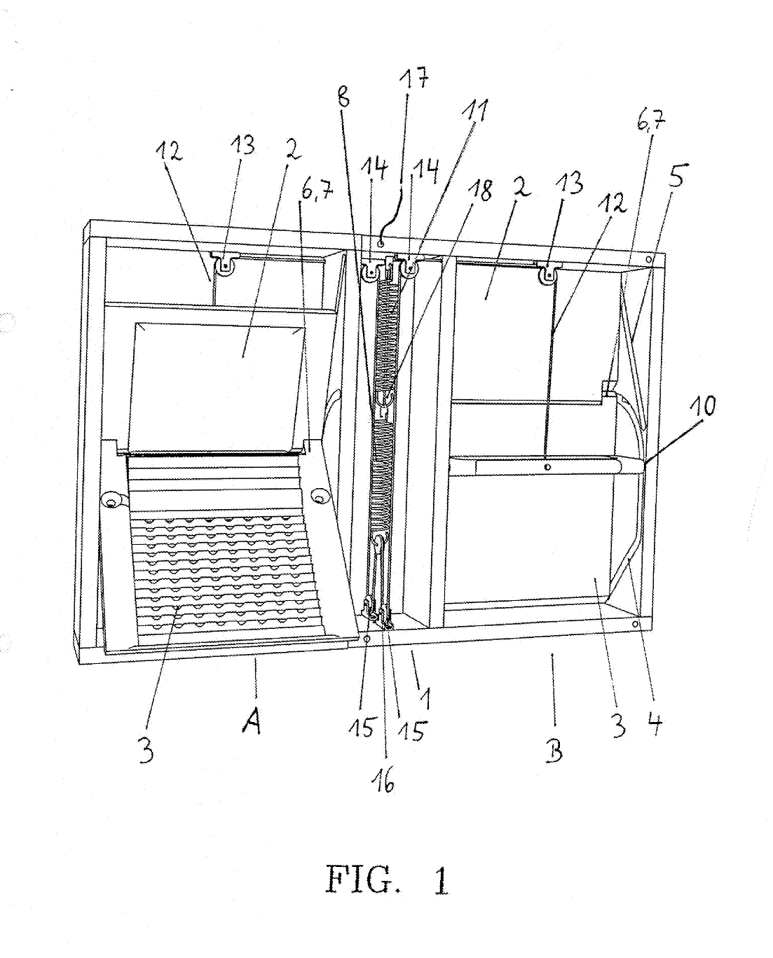

FIG. 1 shows a perspective view from the front of one embodiment of the foot-operated door opener according to the invention, namely, a foot-operated actuator element 1 having two foot-operated rockers A and B, so that in the installed state, i.e., in particular in a door, they may be operated from both sides (front side and back side of a door). The two footrest rockers A and B each have upper and lower foot surface elements 2, 3, respectively, which in each case are articulatedly connected to one another via a hinged connection 6, whereby the hinged connection 6, as a main component, contains a rod-shaped guide slot running element 7. The upper foot surface element 2 is guided in a first guide slot 5 by means of the rod-shaped guide slot running element 7, and is guided in a second guide slot 4 by means of a further rod-shaped guide slot running element 10. The lower foot surface element 3 is guided in the guide slot 4 by means of the rod-shaped guide slot running element 7, and is guided in the guide slot 4 by means of a further rod-shaped guide slot running element 10.

A cable element 12 directly engages with the guide slot running element 10, the cable element 12 being redirected via a first and second deflection roller 13, 14, respectively, toward a further deflection roller 15, and lastly, to a deflection roller 16 with which the first spring element 8 directly engages. The two spring elements 8 and 11 are connected to one another in an interlocked manner (at point 18), the second spring element 11 being directly connected to an upper frame part of the foot-operated actuator element 1. Due to the fact that the foot-operated actuator element 1 has two footrest rockers A and B having an identical configuration but with different orientations, the cable element 12, in each case viewed from a footrest rocker, extends further over the deflection roller 16, so that the cable element 12 is ultimately connected to both guide slot running elements 10.

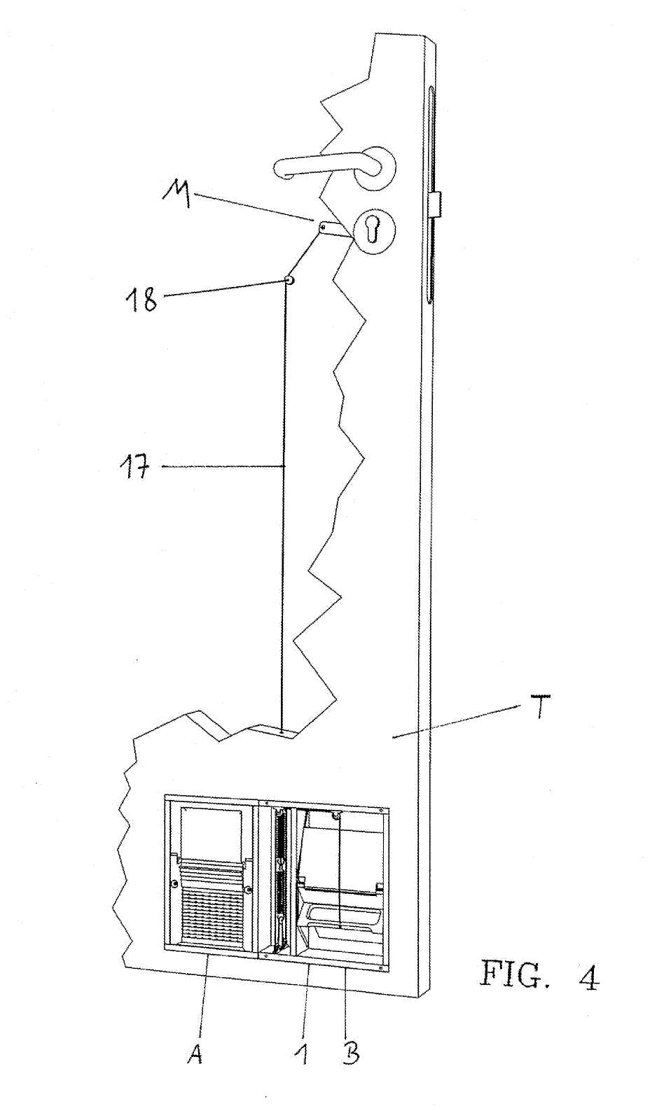

A cable-shaped actuator element 17 engages with the lower end of the second spring element 11 (i.e., at point 18) and with a door opening mechanism M, the cable-like actuator element 17 being adapted on-site to the geometric relationships via a deflection roller 18 (see FIG. 4).

As the result of activation, in particular by means of a foot, by placing the foot on the first foot surface element 3, when an appropriate force is applied the first and second foot surface elements 2, 3, respectively, are specifically pivoted according to the courses of the two guide slots 4 and 5, so that only a portion of the lower foot surface element 3 projects beyond the door profile upon full activation.

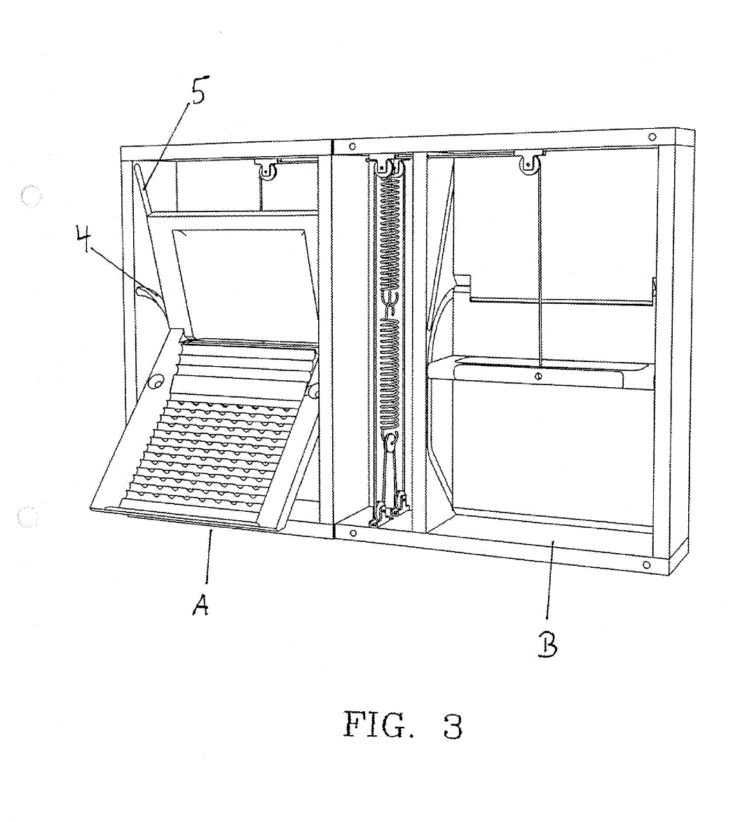

The guide slot running elements 7, 10, and 11 are guided, vertically downwardly or once again diagonally, in a diagonal or paraboloid manner according to the courses of the guide slots 5 and 4 (see FIG. 1 and in particular FIG. 3).

By setting the spring constants of the two spring elements 8 and 11 with respect to one another, but also as a result of the ratio of the lengths of the spring elements, the operator is able to activate, in this case along the vertical course segment of the guide slot 4, the engaged door opening mechanism M of the door T to be opened, with fine adjustment, and if necessary, slowly and carefully, in order to allow the door to then be correspondingly opened in a fine-motor manner. Of course, the spring constants and the dimensions of the springs may be set in a ratio to one another so that, for example, in a safety-relevant area it is possible to open the door only in the lower third of the diagonal course of the guide slot 4 (for example, in fire hazard areas in order to limit misuse to the greatest extent possible).

When the foot surface elements 2 and 3 retract, or after the lower foot surface element 3 is released, respectively, the two foot surface elements 2 and 3 are pulled back into their neutral position, so that the guide slot running elements 7, 10, and 11 run in their guide slots from bottom to top, whereby due to the different configurations of the courses of the two guide slots 4 and 5 and the fact that the upper course of the guide slot 4 has a paraboloid-like configuration, the retraction is associated with a certain frictional force, and thus with a certain braking effect, in order to avoid loud, uncontrolled rebound. It is thus also possible to configure the courses of the guide slots, viewed from an absolute standpoint but also relative to one another, as well as the dimensions of the guide slot running elements themselves in the guide slots themselves, in such a way that a relatively slow, smooth retraction into the neutral position is possible, since the two spring elements 8 and 11 engage with the guide slot running element 10 via the cable-like element 12, and thus exert a corresponding force on both foot surface elements 2 and 3.

The second spring element 11 is advantageously configured based on its spring constant and in particular the length dimension with respect to the cable-like actuator element 17 in such a way that when the two foot surface elements 2 and 3 are in the unactivated, and thus the neutral, state, and are in the folded-back state, no force acts on the door opening mechanism M, and when the cable-shaped actuator element 17 has an appropriate length dimension, a certain amount of play (i.e., with a certain overlength) may even be achieved, so that in the case of activation of the foot surface elements 2 and 3, a force acts on the door opening mechanism M only after a certain degree of pivoting, in order to ensure in special cases that not until a certain degree of pivoting is it actually possible to open a door T in question, and to prevent inadvertent opening of such a door T (which is important for safety-relevant areas).

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Foot-operated door opener, comprising:
a) a foot-operated actuator element, the foot-operated actuator element configured for being situated in a lower area of a door having an interior and exterior, for opening the door;
b) the foot-operated actuator element having an upper and a lower foot surface element which are articulatedly connected to one another and, when operated by a foot, each upper and lower foot surface element pivots at least partially into the interior of the door; and
c) at least one of the upper and lower foot surface elements being guided in a guide slot.

2. Foot-operated door opener according to claim 1, wherein:
a) the upper foot surface element is guided in a first guide slot and the lower foot surface element is guided in a second guide slot; or
b) the upper and the lower foot surface elements are guided in a single guide slot; or
c) the upper foot surface element is guided in a second guide slot and the lower foot surface element is guided in a first guide slot.

3. Foot-operated door opener according to claim 2, wherein:
a) each of first and second guide slots includes a course, and the courses of the two guide slots are different.

4. Foot-operated door opener according to claim 2, wherein:
a) each of first and second guide slots includes a course, and the courses of at least one of the two guide slots includes a diagonal course.

5. Foot-operated door opener according to claim 3, wherein:
a) the second guide slot includes a paraboloid-like course.

6. Foot-operated door opener according to claim 5, wherein:
a) a portion of the second guide slot has a diagonal course.

7. Foot-operated door opener according to claim 5, wherein:
a) a portion of the second guide slot has a vertical course.

8. Foot-operated door opener according to claim 3, wherein:
a) the course of the second guide slot has a paraboloid-like course, followed by a vertical course, and then by a diagonal-like course.

9. Foot-operated door opener according to claim 1, wherein:
a) the upper and lower foot surface elements are articulatedly connected by a hinged connection, and the hinged connection of the upper and lower foot surface elements is achieved by use of at least one guide slot running element, a) which is guided in the first guide slot; or b) which is guided in the second guide slot; or c) which is guided in a single guide slot.

10. Foot-operated door opener according to claim 1, wherein:
a) a first spring element directly or indirectly engages with a foot surface element in such a way that the foot surface element is pulled into a neutral position without foot resistance from an operator.

11. Foot-operated door opener according to claim 10, wherein:
a) each of the first and second guide slots includes a course, and the courses of the two guide slots are different, so that releasing the foot surface element causes at least partial retraction into the neutral position with frictional guiding of the first, or an additional, guide slot running element.

12. Foot-operated door opener according to claim 10, wherein:
a) the first spring element engages with the first, or an additional, guide slot running element.

13. Foot-operated door opener according to claim 10, wherein:
a) the first spring element, or additionally a further second spring element, directly or indirectly engages with an opening mechanism of the door.

14. Foot-operated door opener according to claim 13, wherein:
a) the spring constants of the two spring elements have different values.

15. Foot-operated door opener according to claim 14, wherein:
a) the spring constants of the two spring elements differ from one another such that the door to be opened is opened in an adjustable manner when the foot-operated actuator element is operated.

16. Foot-operated door opener according to claim 1, wherein:
a) the door has a profile, and the foot-operated door opener is essentially projection-free beyond the door profile in the unactivated state.

17. Door having a foot-operated door opener according to claim 1.

18. Use of a foot-operated door opener according to claim 1 for installation in a door.
